(19) United States
(12) Patent Application Publication
(10) Pub. No.: US 2015/0193888 A1
(43) Pub. Date: Jul. 9, 2015

(54) TECHNIQUES FOR DETERMINING RELATIONSHIP INFORMATION

(71) Applicant: Linkedln Corporation, Mountain View, CA (US)

(72) Inventor: Sameer Sayed, San Ramon, CA (US)

(73) Assignee: Linkedln Corporation, Mountain View, CA (US)

(21) Appl. No.: 14/147,858

(22) Filed: Jan. 6, 2014

(51) Int. Cl. G06Q 50/00; H04L 29/08

(52) U.S. Cl. CPC G06Q 50/01; H04L 67/306

(57) ABSTRACT

A method of proposing actions for users to take with respect to a social networking site is disclosed. Activity-location profiles for users of a social networking site are generated. The activity-location profiles are based on an analysis of locations and activities of each of the users over a time period. A recommendation is generated for at least one of the users. The recommendation is based on an analysis of the activity-location profiles of the at least one of the users and activity-location profiles of other users. The recommendation proposes an action for the at least one of the users to take with respect to the social networking site.

### TECHNICAL FIELD

This application relates generally to the technical field of social networking, and, in one specific example, to determining other people a person may know or be interested in based on activity and location profiles.

### BACKGROUND

A social networking site (e.g., Facebook or LinkedIn) may enable users to declare their relationships (e.g., as colleagues, acquaintances, friends, fans, followers, etc.) with each other. For example, a first person may declare himself to be a friend of a second person. The second person may then confirm the declaration of friendship of the first person. Similarly, the first person and the second person may acknowledge having a professional relationship with one another (e.g., as having worked together as colleagues for a current or past employer). For various reasons, an operator of the social networking site may wish to encourage users to establish, specify, or acknowledge their relationships with other users.

### BRIEF DESCRIPTION OF THE DRAWINGS

Some embodiments are illustrated by way of example and not limitation in the figures of the accompanying drawings in which:

FIG. 1 is a network diagram depicting a client-server system, within which various example embodiments may be deployed;

FIG. 2 is a block diagram illustrating example modules that may implement various example embodiments;

FIG. 3 is a flow chart illustrating example operations of a method of adapting content for presentation to a user during a commute of the user;

FIG. 4 is a flow chart illustrating example operations of a method of reminding a user of upcoming milestones in a commute of the user;

FIG. 5 is a flow chart illustrating example operations of a method of providing a user of a reminder of an approaching milestone of a commute in combination with a content item that is likely to be of interest to the user based on a context of the commute;

FIG. 6 is a flow chart illustrating example operations of a method 600 of providing alerts pertaining to a pattern of commuting by a user and content for presentation to the user during the commuting by the user; and

FIG. 7 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

In various embodiments, a method of proposing actions for users to take with respect to a social networking site is disclosed. Activity-location profiles for users of a social networking site are generated. The activity-location profiles are based on an analysis of locations and activities of each of the users over a time period. A recommendation is generated for at least one of the users. The recommendation is based on an analysis of the activity-location profiles of the at least one of the users and activity-location profiles of other users. The recommendation proposes an action for the at least one of the users to take with respect to the social networking site. As an example, the recommendation may propose that a user declare or acknowledge a relationship with another person that the person knows. As another example, the recommendation may propose that the user become a follower of one or more other users that the user may be interested in.

This method and other methods or embodiments disclosed herein may be implemented as a computer system having one or more modules (e.g., hardware modules or software modules). Such modules may be executed by one or more processors of the computer system. This method and other methods or embodiments disclosed herein may be embodied as instructions stored on a machine-readable medium that, when executed by one or more processors, cause the one or more processors to perform the instructions.

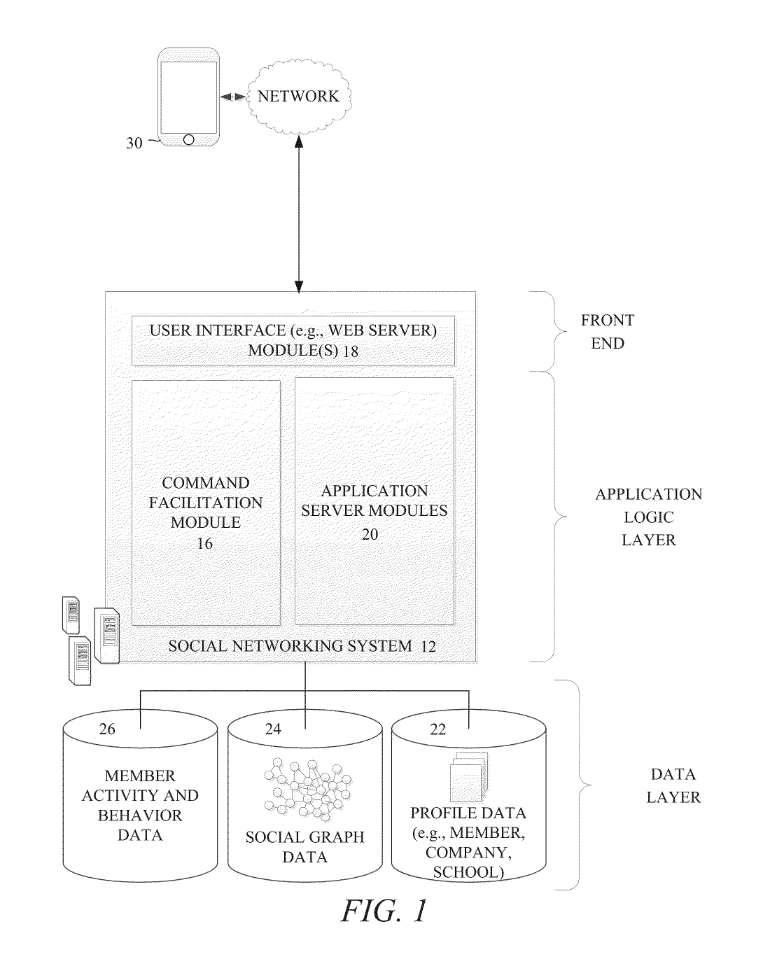

FIG. 1 is a network diagram depicting a server system (e.g., social networking system 12) that includes a command facilitation module 16 for responding to requests or commands received from a mobile computing device 30, consistent with some embodiments of the present invention. As described in greater detail below, the command facilitation module 16 receives commands or requests from mobile computing devices, such as that with reference number 30 in FIG. 1. In various embodiments, the command or request may include information, such as a member identifier uniquely identifying a member of the social networking service (e.g., corresponding to a user of the mobile computing device 30), location information identifying a member's current location, an activity identifier identifying a member's current activity state, and so on. Accordingly, the command facilitation module 16 may perform an action on behalf of the user based in part on the information received with the command or request.

As shown in FIG. 1, the social networking system 12 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module (e.g., a web server) 18, which receives requests from various client-computing devices including one or more mobile computing devices 30, and communicates appropriate responses to the requesting client computing devices. For example, the user interface module(s) 18 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile computing devices and mobile-specific operating systems.

As shown in FIG. 1, the data layer includes several databases, including a database 22 for storing data for various entities of the social graph, including member profiles, company profiles, educational institution profiles, as well as information concerning various online or offline groups. Of course, with various alternative embodiments, any number of other entities might be included in the social graph, and as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database with reference number 22.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 12, information relating to the member's activity and behavior may be stored in a database, such as the database with reference number 26.

The social networking system 12 may provide a broad range of other applications and services that allow members the opportunity to share and receive information, often customized to the interests of the member. For example, with some embodiments, the social networking system 12 may include a photo sharing application that allows members to upload and share photos with other members. With some embodiments, members of a social networking system 12 may be able to self-organize into groups, or interest groups, organized around a subject matter or topic of interest. With some embodiments, members may subscribe to or join groups affiliated with one or more companies. For instance, with some embodiments, members of the social networking service 12 may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with the social graph data of the database with reference number 24.

The application logic layer includes various application server modules 20, which, in conjunction with the user interface module(s) 12, generates various user interfaces with data retrieved from various data sources or data services in the data layer. With some embodiments, individual application server modules 20 are used to implement the functionality associated with various applications, services and features of the social networking system. For instance, a messaging application, such as an email application, an instant messaging application, or some hybrid or variation of the two, may be implemented with one or more application server modules 20. A photo sharing application may be implemented with one or more application server modules 20. Similarly, a search engine enabling users to search for and browse member profiles may be implemented with one or more application server modules 20. Of course, other applications and services may be separately embodied in their own application server modules 20.

As illustrated in FIG. 1, one application server module is a command facilitation module 16. Accordingly, the command facilitation module 16 may facilitate the issuing of commands by the user, as will be described in more detail below.

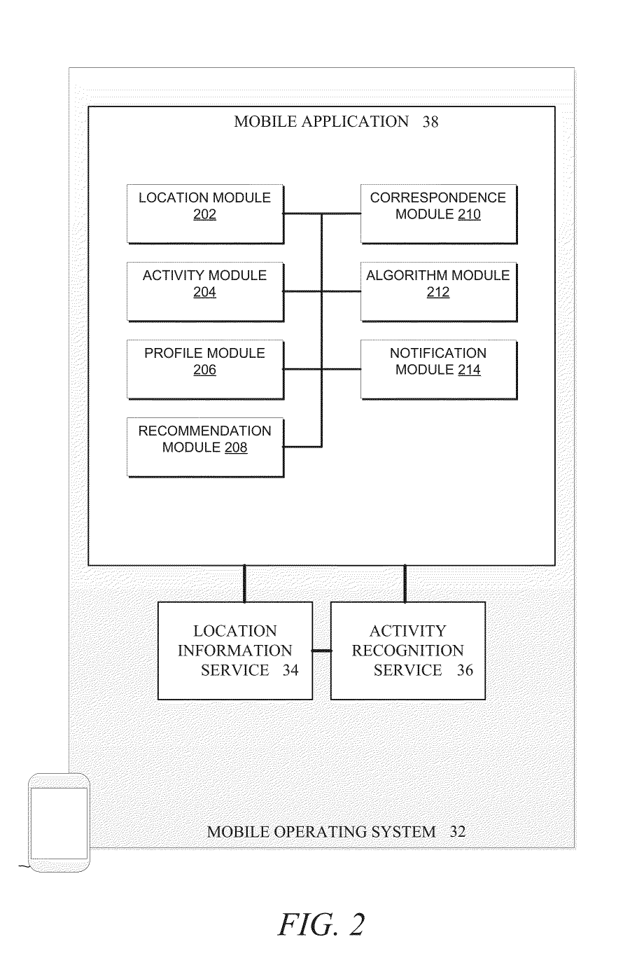

FIG. 2 is a functional block diagram depicting some of the functional modules of a mobile computing device 30, consistent with some embodiments of the invention. As is understood by skilled artisans in the relevant computer- and mobile device-related arts, each module or engine shown in FIG. 2 represents a set of executable software instructions and the corresponding hardware (e.g., memory, processor, sensor devices) for executing the instructions, and deriving or generating relevant data. To avoid obscuring the inventive subject matter with unnecessary detail, various functional modules and engines that are not germane to conveying an understanding of the inventive subject matter have been omitted from FIG. 2.

As illustrated in FIG. 2, the mobile computing device 30 includes a mobile operating system 32, which has both a location information service (or, module) 34 and an activity recognition service (or, module) 36. With some embodiments, one of these two services may be a sub-component of the other, or may be combined as a single service or module. In any case, the services 34 and 36 provide an application-programming interface (API) that allows the mobile application 38 to invoke various functions, or access certain data, that are provided and/or derived by the respective services. For example, the location information service 34 may operate with one or more location sensing components or devices (e.g., a GPS component, WiFi® triangulation, iBeacons or other indoor positioning systems, and so forth) to derive location information representing the current location of the mobile computing device 30, as well as the current speed and direction of travel. The mobile application 38, by making an API request to the location information service 34, can obtain this location information (e.g., current location, direction and speed of travel, etc.) of the mobile computing device. Accordingly, with some embodiments, the location information can be included with a content request communicated to a content server, thereby allowing the content server to select content items based at least in part on the current location of the user, or the current location and direction and speed of travel.

With some embodiments, the activity recognition service 36 may be configured to receive information or data signals from one or more motion sensing components or devices, such as an accelerometer, compass, and/or gyroscope. In addition, the activity recognition service may receive location information from a location sensing component or device, such as a GPS component, indoor positioning system (or other location sensing component), and/or a wireless network interface. By analyzing the information or data signals generated by these various sensing components, the activity recognition service 36 can generate information representing the inferred physical activity state of the member of the social networking service. For example, the various sensing components may generate a combination of signals from which the activity recognition service can infer a particular activity state of the member, to include, but certainly not to be limited to: walking, running, sitting, standing, driving in a vehicle, and riding in a vehicle.

With some embodiments, the inferred physical activity state of the member may be represented by a single activity status identifier that is assigned a particular value to represent the most likely current physical activity state of the member (e.g., walking=1, running=2, sitting still=3, standing=4, etc.). In other embodiments, each of several activity status identifiers may be assigned a value or score representing a measure of the likelihood that a member is in a certain physical activity state (e.g., walking=0.90, running=0.45, sitting still=0.03, standing=0.11, etc.). In yet other embodiments, the inferred physical activity state of the member may be represented by a single activity status identifier that is assigned a particular value to represent the most likely current physical activity state of the member, in combination with another value that represents the likelihood or probability that the member is in the inferred physical activity state (e.g., activity state identifier=1, confidence level=0.90). Of course, an activity status identifier may be encoded in any of a number of other ways as well.

Accordingly, when a user of the mobile computing device is walking, an accelerometer, gyroscope and compass will generally detect motion (and direction) consistent with such activity. An activity status identifier may be assigned a particular value (e.g., a number) that identifies the member's current physical activity state, for example, walking or running. Alternatively, a specific activity status identifier for walking may be assigned a value or score representing the probability or likelihood that the member is at that moment engaged in the particular physical activity—that is, for example, walking. Similarly, when a user places his or her mobile computing device flat on a desk or table top, the sensing components will generally detect motion (or lack thereof) that is consistent with such activity.

In some instances, in addition to signals generated by an accelerometer, gyroscope and/or compass, the activity recognition service 36 may also analyze information received from other data sources, to include information from one or more location sensing components (e.g., GPS, iBeacon, etc.). By analyzing location information, including the current location (e.g., latitude and longitude coordinates) as well as the direction and speed of travel, the activity recognition service 36 can make meaningful inferences about the member's current activity state. For example, an accelerometer and gyroscope of a mobile computing device may detect motion consistent with a member that may be running, while the member's current location, speed and direction of travel, as evidenced by information received via a GPS component, may indicate that the member is currently on a well-known trail or path, and moving in a direction and speed consistent with the member running on the trail or path. Accordingly, the more information from which the activity status identifier is inferred, the higher the confidence level may be for the particular inferred activity status identified.

With some embodiments, the activity recognition service 36 may use a mobile computing device's network activity status to determine the member's current physical activity state. For example, if a mobile computing device is currently paired and actively communicating with another Bluetooth® device known to be in an automobile or vehicle of the member, and the other sensors are detecting signals consistent with the mobile computing device being within a moving automobile or vehicle, the activity recognition service 36 may indicate a high probability that the member is currently driving. Similarly, if the sensors are detecting signals consistent with the mobile computing device being within a moving automobile or vehicle, but the mobile computing device is not currently paired or connected with a known data network (Bluetooth®, personal area network, controller area network, etc.), the activity recognition service 36 may indicate a high probability that the member is currently riding, but not driving, in a vehicle.

With some embodiments, a mobile application 38 may register a request with the activity recognition service 36 to receive periodic updates regarding the inferred activity state of the user of the mobile computing device 30 who is a member of the social networking service. Accordingly, after receiving the request, the activity recognition service 36 may periodically communicate information to the mobile application 38 about the user's inferred activity state. With some embodiments, the activity recognition service 36 may only provide the mobile application 38 with information concerning the current inferred activity status when there is a change from one status to another, or, when the confidence level for a particular activity status exceeds some predefined threshold. In other embodiments, the mobile application 38 may periodically poll the activity recognition service 36 for the current inferred activity state.

Referring again to FIG. 2, the mobile application 38 includes various modules 202-214. A location module 202 may be configured to determine physical locations of users over a time period. An activity module 204 may be configured to determine activities of users (e.g., at particular locations or times), as will be described in more detail below. A profile module 206 may be configured to generate location-activity profiles of users based on their determined locations and activities. A recommendation module 208 may be configured to generate a recommendation to a user based on the location-activity profiles. The recommendation may include a proposed action for the user to perform with respect to the social networking site, as will be described in more detail below. A correspondence module 210 may be configured to determine similarities between the location-activity profiles of users. An algorithm module 212 may be configured to determine people that a person may know or be interested in, as will be described in more detail below. A notification module 214 may be configured to notify a user of recommendations based on the location-activity profiles.

Although the functionality corresponding to modules 202-214 is depicted and described as being implemented on the client side (e.g., by the mobile application 38), in various embodiments, some or all of the functionality corresponding to modules 202-214 may be implemented on the server side (e.g., by the command facilitation module 16). Thus, in various embodiments, one or more algorithms implemented on the client side or server side may utilize information collected about the user, such as the member's current activity, current location, current gesture, past activity and behavior, social/graph data, profile data, and so on, to facilitate the issuing of a command by the user with respect to the social networking system 12, such as declaring or acknowledging a relationship with the user of the additional mobile device.

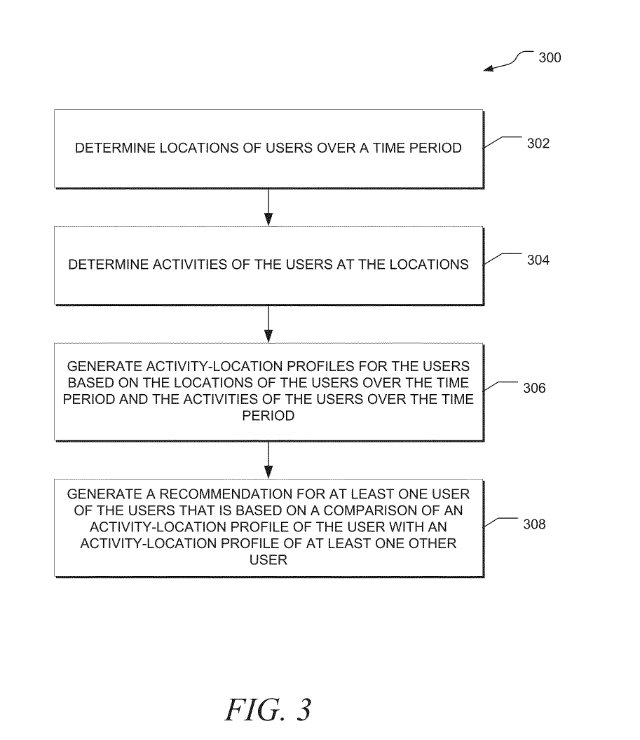

FIG. 3 is a flow chart illustrating example operations of a method 300 of generating a recommendation based on data derived from activity-location profiles of users. In various embodiments, the method 300 is implemented by one or more the modules 202-214 of FIG. 2. At operation 302, the location module 202 may determine physical locations of users over a time period. For example, the location module 202 may determine that, over a 24-hour period from Monday to Tuesday, a user was at a home in the morning and evening and at a workplace in the afternoon. In various embodiments, the location module 202 may base its determination on communications with the location information service 34, the activity recognition service 36, or the command facilitation module 16.

At operation 304, the activity module 204 may determine activities of users. For example, the activity module 204 may determine that a person is sitting at a first location, moving vigorously at a second location, and lying motionless for several hours at a third location. The activity module 204 may determine that activity of the user based on sensors associated with a mobile device that the user is carrying. For example, based on an analysis of patterns of data obtained from such sensors as accelerometers, gyroscopes, magnetometers, barometers, compasses, GPS sensors, audio sensors, inertial sensors, video sensors, and so on, included in a device being carried by the user, with patterns of data corresponding to known activities, the activity module 204 may determine that the user is performing a particular activity (e.g., at a particular location and time). Thus, the activity module 204 may infer, for example, that the user is working at the first location, exercising at second location, and sleeping at the third location. In various embodiments, the activity module 204 may base its determination on communications with the location information service 34, the activity recognition service 36, or the command facilitation module 16.

At operation 306, the profile module 206 may generate activity-location profiles for the users. For example, the profile module 206 may determine that a person usually commutes between his home and his workplace at particular times on weekdays. Or the profile module 206 may determine that the person usually exercises at particular locations and times. The activity-location profile may include a mapping of historical locations and activities of a user. For example, an activity-location profile may be represented as icons on a map (e.g., a Google map) that visually indicate activities that the user was performing at various locations over a particular time period. Icons may be overlaid at the location, each icon representing the activity that the user performed at that location. Furthermore, the icons may be connected in a trail based on time, direction, or other data.

At operation 308, the recommendation module 208 generates a recommendation for a user based on their activity-location profiles. For example, the recommendation module 208 may generate a recommendation that a first person declare or establish a relationship with a second person on a social networking site based on a determination that the first person and the second person exercise at the same location or time. As another example, the recommendation module 208 may recommend that a first person and a second person carpool from a first location to a second location at a particular time on a particular weekday based on a determination that the first person and the second person have a similar commute.

In various embodiments, the recommendation module 208 may determine a recommendation to make based on weightings associated with various activities and locations. Such weightings may be designated by and administrator or the user. For example, a user who is interested in receiving recommendations pertaining to a particular activity that the user engages in, such as exercising, may be weighted more heavily than other activities that the user engages in, such as working, eating, or sleeping. In this case, the recommendation module 208 may generate a recommendation that a first person declare a relationship with a second person based on a determination from the activity-location profiles of the first person and the second person that the first person and the second person exercise at locations nearby to one another at approximately the same time on weekdays or weekends, based on a weighting assigned by the first user to the exercising activity.

In various embodiments, the recommendation module 208 may determine recommendations based on combinations of weightings assigned by a first user and weightings assigned by a second user. For example, a first user may be matched to a second user based on both the first user and the second user giving relatively high weightings to a particular activity that both the first user and the second user engage in. Or the first user may not be matched to the second user based on the second user giving a relatively low rating to a particular activity, even though the first user gave the particularly activity a relatively high rating. In various embodiments, the recommendation module 208 may rank recommendations based on any combination of similarities between weightings assigned to activities by users, locations at which users performed that activities, and time periods in which the users engaged in those activities.

In various embodiments, the recommendation module 208 may determine recommendations based on profile attributes specified by the users in addition to activity and location data. Users may also give weightings to profile data specified by the users or determined about the users, such as their profession, employment history, activities, interests, and so on. In some embodiments, weightings for particular determined activities may be calculated based on profile data submitted by the users. Such profile data may include any data that the user chooses to submit, such as data such as work experience, projects, skills, expertise, education, interests, organization memberships or affiliations, recommendations, declared or acknowledged connections, or other private or public information. Thus, recommendations may be based on similarities between activity and profile data of the users as well as weightings assigned to the activity data and profile data. In various embodiments, the profile module 206 may store past or current activity and location data for a user in one or more data structures associated with the user, such as matrixes or arrays, for quick or efficient access and use (e.g., for comparisons).

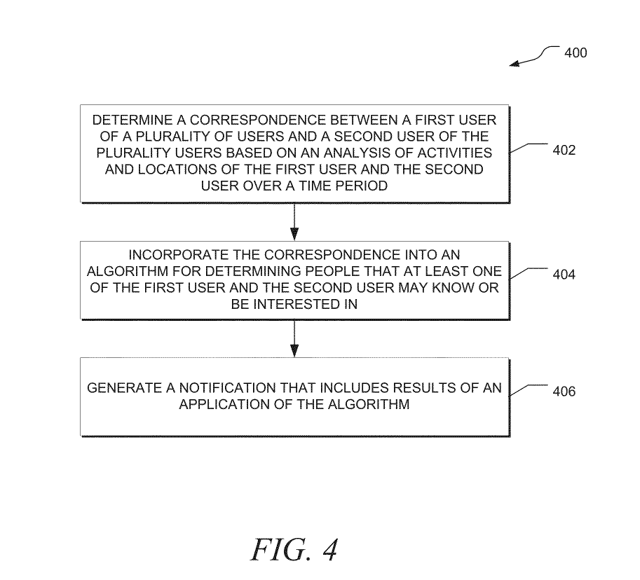

FIG. 4 is a flow chart illustrating example operations of a method 400 of notifying a user of people he may know or be interested in. In various embodiments, the method 400 is implemented by one or more the modules 202-214 of FIG. 2. At operation 402, the correspondence module 210 determines a correspondence between a first user of a plurality of users and a second user of the plurality of users based on an analysis of activities and locations of the first user and the second user over a time period. For example, the correspondence module may determine that a first person and a second person live in a same neighborhood. As other examples, the correspondence module may determine that the first person and the second person exercise at the same gym, work at the same company, travel repeatedly to or from the same location, and so on.

At operation 404, the algorithm module 212 incorporates the correspondence into an algorithm for determining people that at least one of the first user and the second user may know or be interested in. For example, when a user accesses a social networking site, the algorithm may generate a list of people that the person may know based on similarities between profiles of the user and profiles of other users. Such profiles may include information about the users, such as their work history, education history, organizational affiliations, interests, areas of expertise, and so on. In various embodiments, the algorithm module 212 may be configured to include information derived from location-activity profiles of the users as an input. In various embodiments, the algorithm module 212 may generate a list of people that a user may know that is filtered or sorted based at least in part on data pertaining to the activities and locations of the users.

At operation 406, the notification module 214 generates a notification that includes results of an application of the algorithm. Thus, a list of people that a user may know or be interested may be presented to the user based at least in part on a similarity between the activities and locations of the user and the activities and locations of other users.

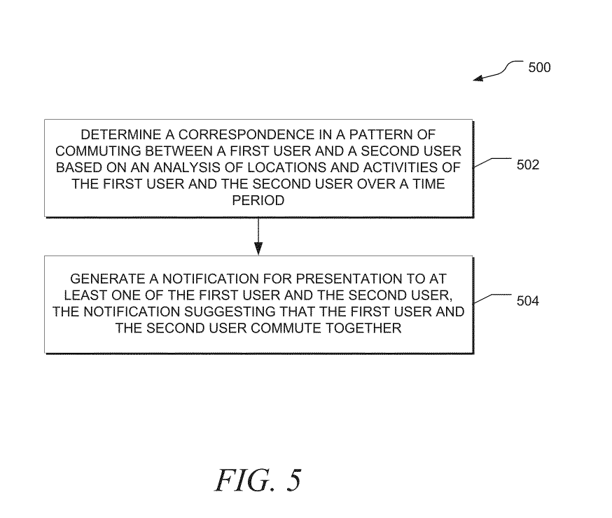

FIG. 5 is a flow chart illustrating example operations of a method 500 of recommending that a first user and a second user commute together. In various embodiments, the method 500 is implemented by one or more the modules 202-214 of FIG. 2. At operation 502, the correspondence module 210 determines a correspondence in a pattern of commuting between a first user and a second user. In various embodiments, the determination of the correspondence is based on an analysis of locations and activities of the first user and the second user over a time period.

At operation 504, the notification module 214 generates a notification for presentation to a least one of the first user and the second user, the notification suggesting that the first user and the second user commute together. For example, based on a determination that the first user and the second user live in the same neighborhood, leave their homes at approximately the same time on weekdays, and travel in the same direction, the notification module 214 may generate a notification to the first user or the second user that includes a recommendation that the first user and the second user commute together on weekdays.

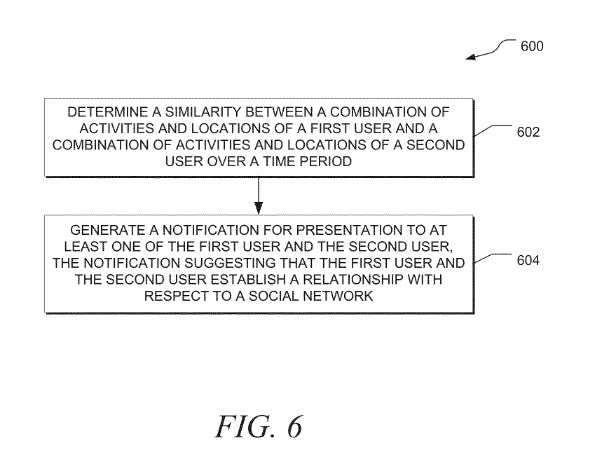

FIG. 6 is a flow chart illustrating example operations of a method 600 of recommending that a first user and a second user establish or confirm a relationship with respect to a social networking site. In various embodiments, the method 600 is implemented by one or more the modules 202-214 of FIG. 2. At operation 602, the correspondence module 210 determines a similarity between a combination of activities and locations of a first user and a combination of activities and locations of a second user over a time period.

At operation 604, the notification module 214 generates a notification for presentation to at least one of the first user and the second user, the notification suggesting that the first user and the second user establish a relationship with respect to a social network. For example, based on a determination that the first user is a group exercise instructor at a gym that both the first user and the second user travel to and exercise at, the notification module 214 may generate a notification for presentation to the second user that includes a recommendation that the second user become a follower of the first user with respect to the social networking site.

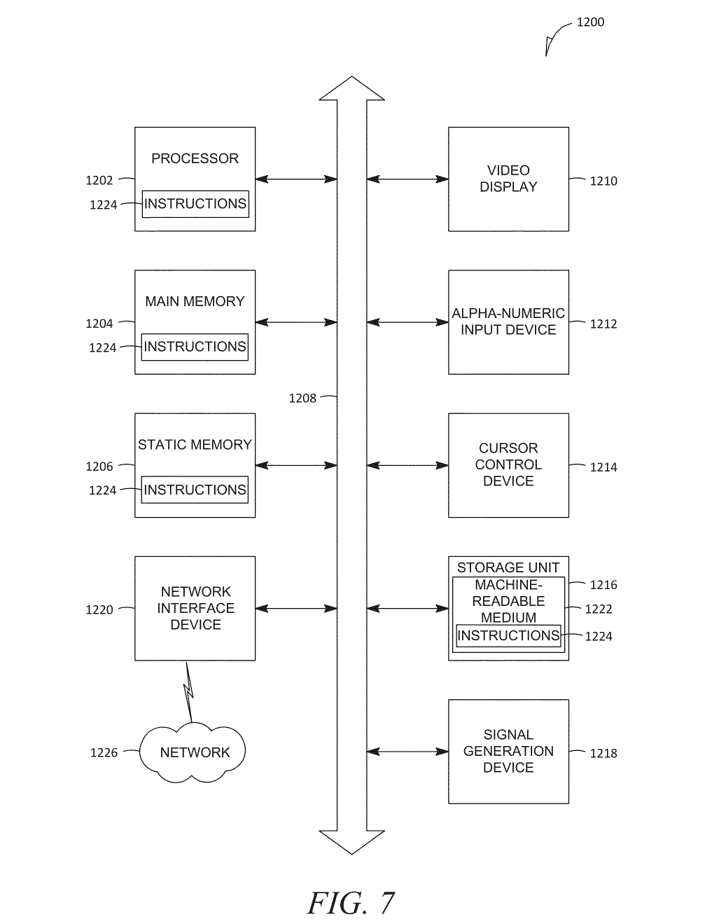

FIG. 7 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a storage unit 1216, a signal generation device 1218 (e.g., a speaker) and a network interface device 1220.

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 may further be transmitted or received over a communications network 1226 using a transmission medium. The network 1226 may be one of the networks 1220. The instructions 1224 may be transmitted using the network interface device 1220 and any one of a number of well-known transfer protocols (e.g., Hyper Text Transfer Protocol (HTTP)). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
generating activity-location profiles for users of a social networking site based on an analysis of locations and activities of each of the users over a time period, the generating of the activity-location profiles including storing activity and location data for the users in data structures associated with the users, the data structures including associations between the locations and activities performed by the users at the locations;
determining probabilities that each of the users will perform particular activities at particular locations at particular times based on the activity and location data stored in the data structures; and
generating a recommendation for at least one of the users based on an analysis of the probabilities, the recommendation proposing an action for the at least one of the users to take with respect to the social networking site, the generating of the recommendation further based on a combination of a weighting assigned to an activity by the at least one user and a weighting assigned to the activity by the at least one of the other users, wherein one or more modules are incorporated into the social networking site to configure one or more processors of the social networking site to perform the generating of the activity-location profiles and the generating of the recommendation.

2. The method of claim 1, wherein the recommendation comes in the form of a notification and the action includes declaring a relationship between the at least one of the users and at least one of the other users.

3. The method of claim 1, further comprising determining the activities of each of the plurality of users based on patterns of data collected from sensors on devices carried by each of the plurality of users.

4. The method of claim 1, wherein the generating of the recommendations is based on an application of an algorithm for determining people that the at least one of the users may know or be interested in.

5. The method of claim 1, wherein the analysis of the activity-location profiles of the at least one of the user to the activity-location profiles of the other users includes mapping of activities to locations.

6. The method of claim 1, further comprising generating a visual depiction of the activity-location profiles of the at least one of the users in comparison to the activity-location profiles of the other users.

7. The method of claim 6, wherein the visual depiction includes a user interface element representing an activity of the at least one of the users overlaid over a depiction of a physical location on a geographic map at which the at least one of the users performed the activity.

8. A system comprising:
one or more modules incorporated into a social networking site to configured one or more processors of the social networking site to, at least:
generate activity-location profiles for users of the social networking site based on an analysis of locations and activities of each of the users over a time period, the generating of the activity-location profiles including storing activity and location data for the users in data structures associated with the users, the data structures including associations between the locations and activities performed by the users at the locations;
determining probabilities that each of the users will perform particular activities at particular locations at particular times based on the activity and location data stored in the data structures; and
generate a recommendation for at least one of the users based on an analysis of the probabilities, the recommendation proposing an action for the at least one of the users to take with respect to the social networking site, the generating of the recommendation further based on a combination of a weighting assigned to an activity by the at least one user and a weighting assigned to the activity by the at least one of the other users.

9. The system of claim 8, wherein the action includes declaring a relationship between the at least one of the users and at least one of the other users.

10. The system of claim 8, further comprising determining the activities of each of the plurality of users based on patterns of data collected from sensors on devices carried by each of the plurality of users.

11. The system of claim 8, wherein the generating of the recommendations is based on an application of an algorithm for determining people that the at least one of the users may know or be interested in.

12. The system of claim 8, wherein the analysis of the activity-location profiles of the at least one of the user to the activity-location profiles of the other users includes mapping of activities to locations.

13. The system of claim 8, further comprising generating a visual depiction of the activity-location profiles of the at least one of the users in comparison to the activity-location profiles of the other users.

14. The system of claim 13, wherein the visual depiction includes a user interface element representing an activity of the at least one of the users overlaid over a depiction of a physical location on a geographic map at which the at least one of the users performed the activity.

15. A non-transitory machine readable medium embodying a set of instructions that, when incorporated into one or more modules of a social networking site, cause one or more processors of the social networking site to perform operations, the operations comprising:
generating activity-location profiles for users of the social networking site based on an analysis of locations and activities of each of the users over a time period, the generating of the activity-location profiles including storing activity and location data for the users in data structures associated with the users, the data structures including associations between the locations and activities performed by the users at the locations;
determining probabilities that each of the users will perform particular activities at particular locations at particular times based on the activity and location data stored in the data structures; and
generating a recommendation for at least one of the users based on an analysis of the probabilities, the recommendation proposing an action for the at least one of the users to take with respect to the social networking site, the generating of the recommendation further based on a combination of a weighting assigned to an activity by the at least one user and a weighing assigned to the activity by the at least one of the other users.

16. The non-transitory machine readable medium of claim 15, wherein the action includes declaring a relationship between the at least one of the users and at least one of the other users.

17. The non-transitory machine readable medium of claim 15, further comprising determining the activities of each of the plurality of users based on patterns of data collected from sensors on devices carried by each of the plurality of users.

18. The non-transitory machine readable medium of claim 15, wherein the generating of the recommendations is based on an application of an algorithm for determining people that the at least one of the users may know or be interested in.

19. The non-transitory machine readable medium of claim 15, wherein the analysis of the activity-location profiles of the at least one of the user to the activity-location profiles of the other users includes mapping of activities to locations.

20. The non-transitory machine readable medium of claim 15, further comprising generating a visual depiction of the activity-location profiles of the at least one of the users in comparison to the activity-location profiles of the other users.
